(19) United States
(12) Patent Application Publication
(10) Pub. No.: US 2010/0045054 A1
(43) Pub. Date: Feb. 25, 2010

(54) Locking Device

(75) Inventor: Anders Holmgren, Stockholm (SE)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Optosolutions Sweden AB, Stockholm (SE)

(21) Appl. No.: 12/308,157

(22) PCT Filed: May 30, 2007
(86) PCT No.: PCT/SE2007/050370

§ 371 Date: Sep. 9, 2009

(30) Foreign Application Priority Data
Jun. 2, 2006 (SE) 0601269-4

(51) Int. Cl. E05C 19/16

(52) U.S. Cl. 292/251.5

(57) ABSTRACT

The invention relates to a locking device comprising a first and a second locking part (2, 4), wherein the second locking part (4), when the locking parts (2, 4) are brought together, moves in relation to the first locking part (2) in a locking direction (L). The first locking part (2) comprises a locking member (2b), comprising a magnet, and a locking member holder (2a), which supports the locking member (2b) without the locking member (2b) being fixed to the locking member holder (2a). The second locking part (4) comprises an actuating part (4b), the locking member (2b) comprises a contact part (2y). Once the actuating part (4b), when moving in the locking direction (L), has passed the contact part (2y), the contact part (2y) moves into the path of the actuating part (4b), so that the locking member (2b), through bearing contact against the locking member holder (2a) and against the actuating part (4b), can prevent movement of the second locking part (4) in a direction opposite to the locking direction (L). When a force generated by a magnetic field is acted upon by the magnet, the contact part (2y) moves out of the path of the actuating part (4b).

### TECHNICAL FIELD

The present invention relates to a locking device comprising a first and a second locking part, which are arranged, in a fitted state of the locking device, to be fixedly connected to a first and a second element respectively, wherein the second locking part, when the locking parts are brought together, moves in relation to the first locking part in a locking direction, and wherein the first locking part comprises a locking member comprising a temporary magnet or a permanent magnet.

### BACKGROUND

Locking devices which are controllable by means of magnetism are known and have been proposed in connection with the design of childproof locks. The locking device can be disposed on the inside of a cupboard door or kitchen drawer, which is unlocked by a “key” with a permanent magnet being brought against the outside the door or drawer for unlocking by a movement in the locking device induced by a magnetic-field-generated force between the “key” and the locking device.

As examples of known solutions, patent specifications U.S. Pat. No. 5,184,405, U.S. Pat. No. 5,076,623, U.S. Pat. No. 6,000,735 and U.S. Pat. No. 5,485,733 can be cited, which describe locking devices having a bolt which is pivotable about an axis, and U.S. Pat. No. 3,744,833, U.S. Pat. No. 3,641,793, U.S. Pat. No. 4,950,842 and U.S. Pat. No. 4,848,812, which describe sliding bolts which are detained in the locking and non-locking position, respectively, with the aid of magnetic or spring force.

A drawback with known solutions having magnetic locking-function control is that they are relatively complicated, comprising a large number of integral structural elements, which makes their production process and fitting in a cupboard, etc. relatively complicated and which implies, moreover, a risk of rapid wear during use.

### SUMMARY

An object of the present invention is to provide a magnetically controllable locking device which has a secure locking function and is simple to produce.

A further object of the invention is to provide a magnetically controllable locking device which has a secure locking function and is wear-resistant.

Another object of the invention is to provide a magnetically controllable locking device which has a secure locking function and is easy to fit.

These objects are achieved with a locking device of the type defined in the introduction, characterized
in that the first locking part comprises a locking member holder, which is arranged to support the locking member without the locking member being fixed to the locking member holder, the locking member being movable in relation to the locking member holder,
in that the second locking part comprises an actuating part, the locking member comprises a contact part, and the locking device is arranged such that, in the fitted state of the locking device, the movement of the contact part out of or into the path of the actuating part is corresponded to by an at least partially upward and an at least partially downward movement, respectively, of the centre of gravity of the locking member,
in that the locking device is arranged such that, in the fitted state of the locking device, and once the actuating part, when moving in the locking direction, has passed the contact part, the contact part moves into the path of the actuating part, so that the locking member, through bearing contact against the locking member holder and against the actuating part, can prevent movement of the second locking part in a direction opposite to the locking direction, and
in that the locking device is arranged such that, when the locking device is in the fitted state and when a force generated by a magnetic field is acted upon by the temporary or permanent magnet, the contact part moves out of the path of the actuating part.

The elements can be mutually interacting elements, for example a cupboard and a door for the cupboard, the locking device being suitable for locking of the elements in a closed position in relation to one another, for example a position which is closed for the door.

For the following representation, the terms locking position of the locking member, in which the contact part is in the path of the actuating part, and opening position of the locking member, in which the contact part is outside the path of the actuating part, are introduced. The centre of gravity of the locking member is in the opening position in a higher position than in the locking position.

By permanent magnet is meant an element which retains its magnetism in the absence of any external magnetic field, and by a temporary magnet is meant an element which is magnetized under the influence of an external magnetic field, but which loses its magnetism when the external magnetic field is removed. A permanent magnet can be made of any suitable material such as sintered neodymium-iron-boron (NdFeB), alnico, nipermag, chromium steel, tungsten steel, or any other suitable steel alloy. A temporary magnet can be made of any suitable material such as permalloy, siliceous steel or soft iron.

The fact that the locking member is supported by the locking member holder without being fixed to the latter means that the locking member is trapped or enclosed, without fixed or hinged fastening to the locking member holder, and without being otherwise connected to the locking member holder, for example via springs, etc. Hence the locking member, solely as a result of its external shape and the internal shape of the locking member holder, is limited to a movement which is substantially parallel with a vertical plane lying parallel with the locking direction, which offers an opportunity to provide the first locking part as a very simple construction comprising just two parts, with simple shapes and simple interaction. Given suitable choices of material, apart from negligible friction losses between the surfaces of the locking member and locking member holder, the movement of the locking member is substantially frictionless even after long use, unlike solutions involving joints or axles, which, after a period of wear, can begin to “seize up”. Moreover, solutions of the latter type involve a large number of structural parts having to be provided.

The fact that the locking member, through bearing contact against the locking member holder and against the actuating part, prevents movement of the second locking part in a direction opposite to the locking direction means that the locking member, through bearing contact in a first contact region against the locking member holder and bearing contact in a second contact region against the actuating part, which second contact region lies farther away in the locking direction than the first contact region, prevents movement of the second locking part in a direction opposite to the locking direction.

The invention means that a movement of the contact part out of and into the path, parallel with the locking direction, of the actuating part is corresponded to by an at least partially upwardly directed and an at least partially downwardly directed movement, respectively, of the centre of gravity of the locking member, which, in combination with the low friction between the locking member and the locking member holder, means that the locking position can be assumed and maintained solely with the aid of gravitational force, without any other aids such as a spring or a magnetic force. In particular, no additional permanent or temporary magnet is needed to force the locking member towards the locking position. In greater detail, as exemplified below with reference to FIG. 3 (#4f, 4g), the actuating part preferably has a first surface region and a second surface region, the first surface region, in the fitted state of the locking device and when the second locking part is close to the first locking part, is situated, in relation to the second surface region, farther away in the locking direction and farther away in a direction parallel with the movement of the contact part out of the path of the actuating part, which means that the contact path, once the first surface region in the locking direction has passed the contact part, moves into the path of the actuating part and the locking member assumes the locking position. In a locking manoeuvre, therefore, the first surface region is able to move past the contact part, whereupon the actuating part comes into contact with the contact part so that the centre of gravity of the locking member is displaced at least partially upwards, whereafter the locking member, once the first surface region has passed the contact part, owing to the gravitational influence, is able once again to move towards the locking position. As is described in greater detail below, the locking member, in the locking position induced by the gravitational force, through bearing contact against the locking member holder and the actuating part, can prevent the locking parts from moving away from each other.

The simple gravitational steering towards the locking position means that the force generated by the magnetic field, here also referred to as the magnetic force, through suitable configuration of the locking member and its holder, can in principle be directed in whichever direction, apart from downwards, which provides great flexibility of design and adaptation of the locking member to different types of elements to be locked together.

In the locking position, the locking member, as has been mentioned, through bearing contact against the locking member holder and the second locking part, can block the movement of the second locking part. It should be pointed out that, during the actual blocking, i.e. in a loaded locking position, here also referred to as the blocking position, the position of the locking member, as is shown in greater detail below with reference to FIGS. 3a and 4, can differ somewhat from the unloaded locking position. Since the locking member, in the locking position, is arranged to assume a blocking position in which it in a first contact region bears against the locking member holder, to be more precise against at least one surface in the locking member holder, and in a second contact region bears against the actuating part, which second contact region lies farther away in the locking direction than the first contact region, the locking force increases when the second locking part is subjected to a force in a direction opposite to the locking direction, for example induced by a person pulling the element to which the second locking part is fixed. In other words, the locking member lies wedged between the actuating part and the locking member holder and an increased force upon the second locking part in a direction opposite to the locking direction increases the clamping force upon the locking member. This means that a secure locking is obtained.

The locking device according to the invention thus offers a simple, secure and wear-resistant solution for locking two mutually interacting elements, for example a cupboard and a door for the cupboard, in a closed position in relation to one another, for example a position which is closed for the door.

The locking direction, at least when the second locking part is close to the first locking part, can be substantially horizontal, the actuating part being arranged to move beneath at least a part of the locking member, preferably beneath the centre of gravity of the locking member. Moreover, the locking member can be elongated, preferably substantially parallelepipedal, the first locking part being arranged such that the locking member, when the contact part (2y) is positioned in the path of the actuating part (4b), is inclined, which inclination is preferably directed downwards in the locking direction. Such a simple shape of the locking member facilitates the production of the locking device. In a preferred embodiment, the locking member is provided in the form of a parallelepipedal elongated permanent magnet. A permanent magnet of this kind is commercially available and this solution therefore offers a very simple and wear-resistant construction. Alternative shapes for the magnet are, of course, possible; for example, it can be elongated with square, round or other cross-sectional shape, and can have end faces which are perpendicular or angled (bevelled) to the longitudinal axis.

Preferably, the first locking part has at least one supporting surface, which at least partially slopes downwards in the locking direction, the locking member being arranged, when the contact part is positioned in the path of the actuating part under the influence of solely gravitational force, to be supported by the supporting surface. According to a preferred embodiment, the locking member is arranged, when the locking device is in the fitted state and when a force generated by a magnetic field is acted upon by the temporary or permanent magnet, to bear against a substantially vertical first inner surface, substantially perpendicular to the locking direction, in the locking member holder.

Preferably, as is exemplified below with reference to FIG. 4, the second locking part comprises an engagement member comprising the actuating part, which engagement member is elongated in the locking direction, and the locking device is arranged such that, if the movement of the second locking part in a direction opposite to the locking direction is prevented, the locking member holder, through contact with the engagement member, prevents or limits the bending of the engagement member in a direction away from the bearing contact of the locking member against the locking member holder. This enables a compact configuration of the locking device, in which the engagement part can slide into the locking member holder to engage with the locking member and, moreover, in the event of an opening attempt, prevents the engagement member from being bent such that the locking member “slips off” the engagement member and disengages. This means, in turn, that the flexural rigidity of the engagement member can be relatively low, thereby implying both material and space savings.

### DESCRIPTION OF THE FIGURES

The invention will be described in greater detail below with reference to the drawings, in which

FIG. 1 shows a cross-sectional view of a locking device according to one embodiment of the invention, fitted in a cupboard and on a door for the cupboard;

FIG. 2 shows a cross-sectional view with the section placed along the line II-II in FIG. 1,

FIGS. 2a and 2b show respectively a perspective view obliquely from above and a perspective view obliquely from below of the respective parts of the locking device in FIG. 1,

FIGS. 3, 3a and 4 show cross-sectional views corresponding to that in FIG. 1,

FIG. 5 shows a cross-sectional view corresponding to that in FIG. 3a, with an additional activation member for controlling the locking device,

FIG. 5a shows a cross-sectional view, corresponding to that in FIG. 1, of the locking device during its fitting,

FIGS. 6, 7, 9, 10 and 11 show cross-sectional views of alternative embodiments of the locking device,

FIG. 8 shows a cross-sectional view of a part of a locking device according to a further alternative embodiment, and

FIGS. 9a and 9b show a side view and front view, respectively, of a part of the locking device in FIG. 9.

### DETAILED DESCRIPTION

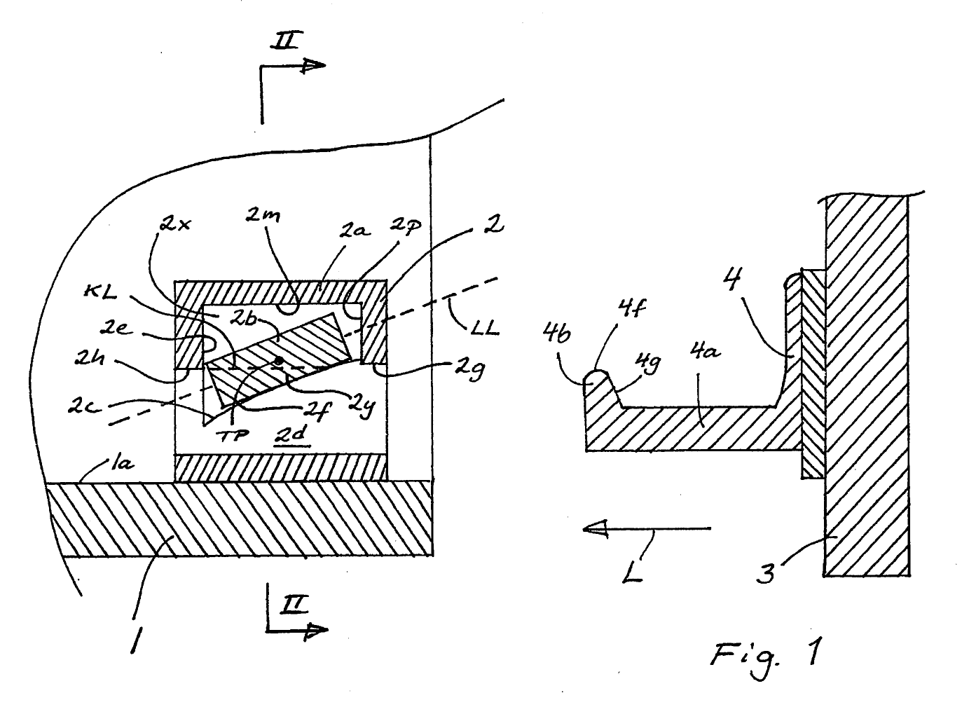

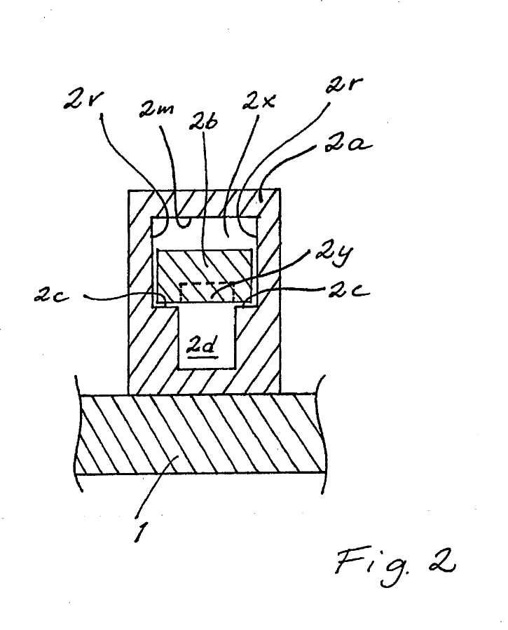

FIG. 1 shows a cross-sectional view of a part of a first element 1, in the form of a cupboard, a lower part of a second element 3, interacting with the first element 1, in the form of a door 3 for the cupboard 1, and a locking device comprising a first locking part 2 and a second locking part 4. The second locking part 4 is preferably made of a non-magnetic material, i.e. it is neither a permanent nor a temporary magnet.

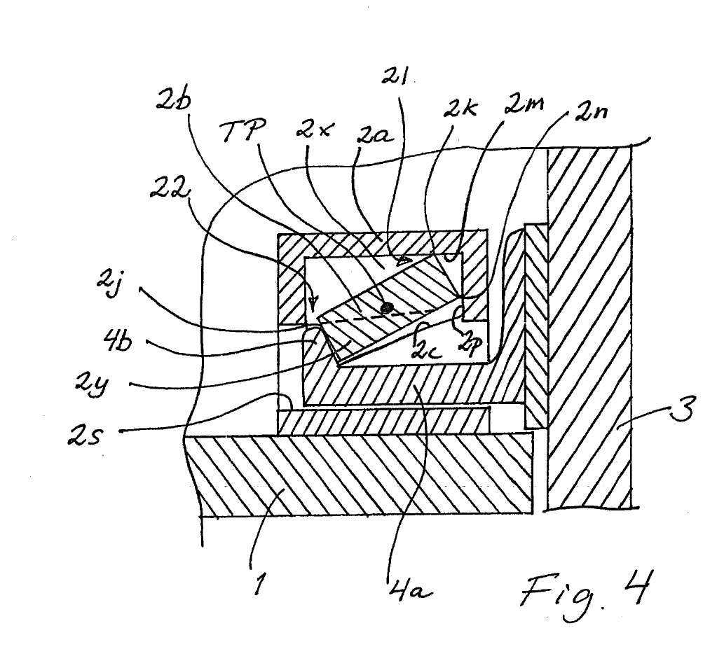

The first locking part 2 and the second locking part 4 are fixedly connected to the first element 1 and the second element 3 respectively. The respective locking parts 2, 4 are preferably fastened by means of a suitable tape, for example one such which is marketed under the name 3M VHB tape. Alternatively, second fastening means can be used, such as screws, glue, rivet, etc. Where screws, rivets, etc. are used, these are preferably made of a non-magnetic material, i.e. they form neither a temporary nor a permanent magnet. In the event of an attempt, in the locked position of the locking device, to pull the elements 1, 3 apart, as a result of the position for the engagement between the locking parts (see FIG. 4 below), a load arises in a part of the fixing surface of the first locking part 2, which load tends to rip the first locking part 2 off from the first element 1. In an advantageous alternative variant of the invention, the bottom surface 2t of the locking member holder 2a therefore has a longer extent in the locking direction L than is shown in FIG. 1. For example, a lower part of the locking member holder 2a can be extended leftwards in FIG. 1, so that a larger fixing surface is produced between the first locking part 2 and the first element 1.

In FIG. 1, the first locking part 2 is shown fixed to an upward-facing inner surface 1a very low down in the cupboard 1, but alternative positionings are possible, for example on a vertical side surface, or a downward-facing surface in the cupboard, tape, for example of the type described above, being able to be applied to a side surface and top surface respectively of the first locking part 2. Of course, a variety of positions in the cupboard are also conceivable for the first locking part, for example on a fixed shelf higher up than is shown in FIG. 1. The elements 1, 3 can alternatively be other types of interacting objects, for example a chest of drawers and a pull-out drawer therein.

In a locking manoeuvre which results in the locking parts being locked together, the second locking part 4 moves in relation to the first locking part 2 in a locking direction, indicated in FIG. 1 with the arrow L. The locking direction L is in this example substantially horizontal, at least when the second locking part 4 is close to the first locking part 2. For this representation, what is meant by the movement of the second locking part 4 in the locking direction L is a relative movement vis-à-vis the first locking part 2. This means that, in an alternative embodiment in which the first locking part 2 is fixed to a movable element, such as a door, and the second locking part 4 is fixed to a fixed element, such as a cupboard, in this representation the second locking part 4, in a locking manoeuvre, is deemed to move in relation to the first locking part 2 in a locking direction. It should also be pointed out that the locking direction L in certain applications, for example when the second locking part is fitted to a door and, in a locking manoeuvre, follows a part-circular path, is dependent on the position of the second locking part 4 (i.e. the door). However, in order to facilitate an understanding of this representation, the locking direction L may be regarded as the movement of the second locking part 4 in relation to the first locking part when the locking parts 2, 4 are close together. The locking direction L may here be regarded as independent of the position of the second locking part 4, since the mutual relative movement of the first and the second locking part 2, 4 can then be deemed to be approximately straight. In a practical case in which the locking parts 2, 4 are fitted to a cupboard and a door for the cupboard respectively, this can be considered to be the case when the door has an opening angle of less than 5 degrees.

The first locking part 2 comprises a locking member holder 2a, which is preferably made of a non-magnetic material. The locking member holder 2a encloses a locking member 2b in the form of a permanent magnet 2b having a somewhat elongated parallelepipedal shape.

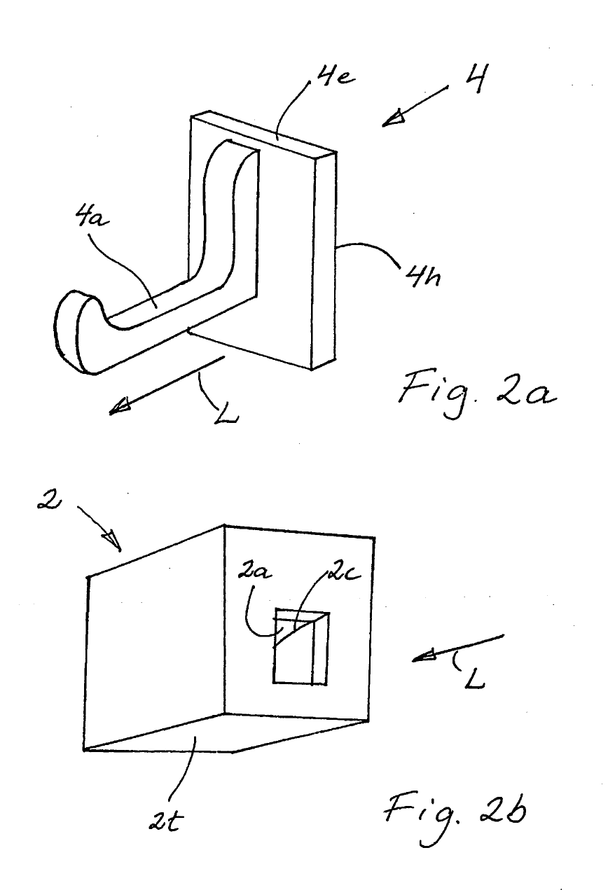

The locking member holder 2a comprises two supporting surfaces 2c, in the form of cams 2c, visible also in FIG. 2 in which the locking direction L is out of the plane of the drawing. The cams 2c extend in the longitudinal direction of the locking member 2b, slope downwards in the locking direction L, are separated with a lead-in space 2d for an engagement member, described in greater detail below. The locking member holder 2a also has a first inner transverse surface 2p, which is substantially vertical and orientated substantially perpendicularly to the locking direction L, as well as, situated at the higher ends of the cams 2c, a second inner transverse surface 2e, situated at the lower ends of the cams 2c, an upper, inner surface 2m, and two substantially vertical inner side surfaces 2r, see FIG. 2. The width of the locking member 2b and the internal width of the locking member holder 2a, i.e. the distance between the inner side surfaces 2r, is adapted such that a small play is present between the locking member 2b and the side surfaces 2r, which play is sufficient for the locking member 2b to be able without significant friction resistance to perform a movement, described in greater detail below, in a vertical plane lying perpendicular to the cross section in FIG. 2. The dimensions of the locking member 2b, and the distance between the inner side surfaces 2r, are further adapted such that the rotation of the locking member 2b about a vertical axis, the rotation thereof about a horizontal axis lying parallel with the locking direction L, and the horizontal movement thereof perpendicular to the locking direction L, apart from the movement which is granted by the said play, are prevented. The locking member holder 2a thus has an inner holder space 2x, which is delimited by the supporting surfaces 2c, the first inner transverse surface 2p, the second inner transverse surface 2e, the upper, inner surface 2m, and the inner side surfaces 2r.

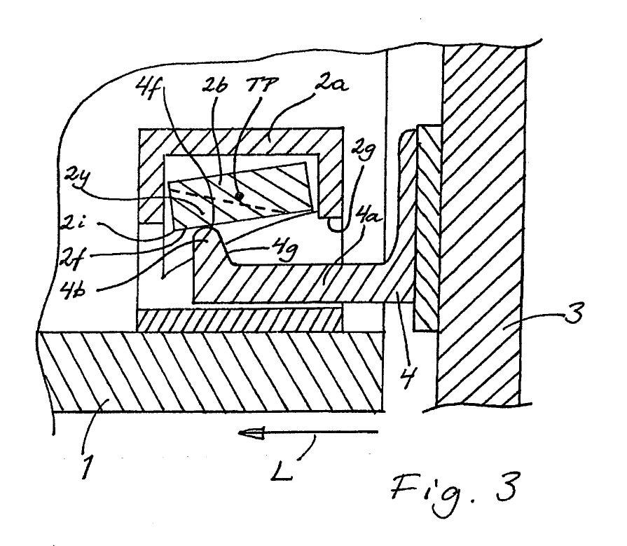

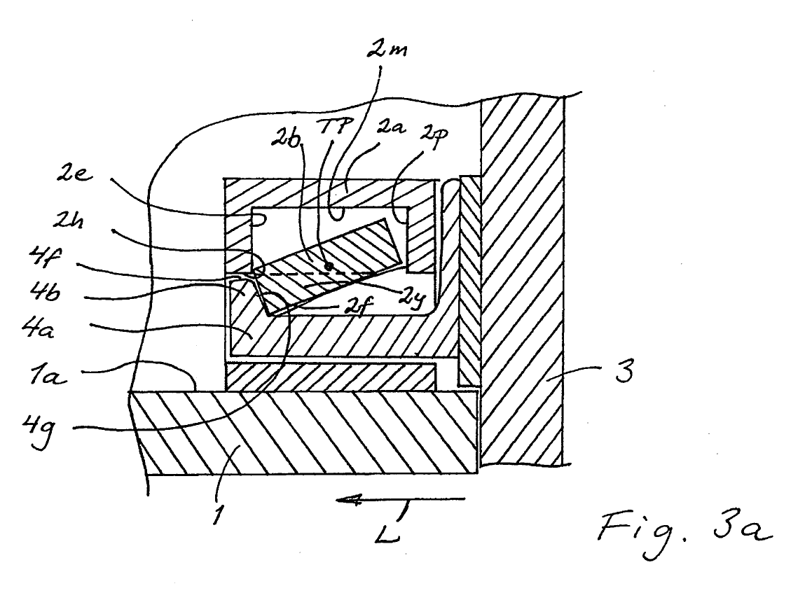

The distance between the first inner transverse surface 2p and the second inner transverse surface 2e is preferably sufficiently large so as not to impede the rotation of the locking member 2b about an imaginary axis lying horizontal and perpendicular to the locking direction L. On the other hand, the distance between the first inner transverse surface 2p and the second inner transverse surface 2e is sufficiently small for the movement of the locking member 2b between an unloaded locking position (see below with reference to FIG. 3a) and a blocking position (see below with reference to FIG. 4) to be limited.

It should be pointed out that, in an alternative embodiment, a part of the locking member 2b can slide down between the supporting surfaces 2c. The locking member is situated in the holder space 2x, and the movement of the locking member 2b, as a result of its external shape, especially its width, and the shape of the holder space 2x, especially its width, is limited such that the movement of its centre of gravity (CG) is substantially limited to an at least partially upwardly or downwardly directed movement in a motional plane lying vertical and parallel with the locking direction L. In addition, the positions of the first inner transverse surface 2p and the upper, inner surface 2m are adapted such that the locking member 2b bears against these in the event of an opening attempt and is not then forced away but remains in the blocking position (see below with reference to FIG. 4). Moreover, the distance between the upper, inner surface 2m and the supporting surfaces 2c is limited such that the locking member 2b cannot rotate to the degree that its ends change place, i.e. so that the locking member does not “flip” round.

The locking member 2b, under the influence of solely the gravitational force and in the absence of the engagement member 4a, assumes a locking position shown in FIG. 1, whereupon it bears against the cams 2c and the second inner transverse surface 2e, so that a longitudinal axis LL of the locking member (marked in FIG. 1 with a dashed line) is angled downwards in the locking direction, and a bottom surface 2f on the locking member 2b is angled such that it is facing partially in a direction opposite to the locking direction L and, between the cams 2c, is exposed in the direction of the lead-in space 2d. The locking member holder 2a has an outer opening 2g and an inner opening 2h, which, viewed from inside the locking member holder 2a, open in a direction opposite to the locking direction L and in the locking direction L, respectively. In other words, the outer opening 2g and the inner opening 2h are situated at the higher and lower ends, respectively, of the cams 2c.

The engagement member of the second locking part 4 comprises an actuating part 4b, in the form of an upwardly directed protrusion 4b, which is arranged, in an imaginary path lying parallel with the locking direction L, to be led into the locking member holder 2a through the outer opening 2g. The protrusion 4b has a first surface region 4f on the highest situated part of the protrusion 4b and a second surface region 4g. When the engagement member moves parallel with the locking direction L, the first surface region 4f is situated, in relation to the second surface region 4g, in the locking direction L farther away from and in a vertical direction closer to the centre of gravity CG of the locking member.

In the locking position of the locking member 2b, a part of the locking member 2b, which part is here referred to as the contact part 2y, is situated in the path of the protrusion 4b. The demarcation for the contact part 2y, and the path of the protrusion 4b, is marked in FIG. 1 and FIG. 2 with a dashed line KL. The contact part 2y is therefore defined at least partially by the relation of the locking member 2b to the locking member holder 2a and the engagement member 4a. More precisely, the contact part 2y is that part of the locking member 2b which, in the locking position of the locking member 2b, is located in the path of the actuating part 4b.

FIG. 2a shows a perspective view of the second locking part 4, which has a flat-shaped fixing part 4e that on a rear side 4h has an adhesive surface produced with the abovementioned tape and coated with a protective film which is removed prior to fixing on the element, for example the door. The engagement member 4a protrudes from a central portion of the fixing part 4e and therefore has a free end. The central position of the engagement member 4a on the fixing part 4e, in the fitted state of the second locking part 4, minimizes bending loads in the adhesive surface in the event of tensile stresses in the engagement member 4a.

FIG. 2b shows a perspective view of the first locking part 2, which has a bottom surface 2t on which an adhesive surface is produced with the abovementioned tape, which adhesive surface is coated with a protective film which is removed prior to fixing on the element, for example the cupboard.

FIG. 3 shows that the engagement member 4a is elongated and, at least in the vicinity of the closed position of the second element 3, is orientated in the locking direction L. When the engagement member 4a moves in the locking direction L, the first surface region 4f passes the contact part 2y of the locking member 2b, whereupon the protruding member 4b comes into contact with the contact part 2y such that the centre of gravity CG of the locking member 2b is displaced at least partially upwards, i.e. the centre of gravity CG has an upwardly directed motional component. More precisely, when the protrusion 4b is led into the first locking part 2 and through the lead-in space 2d, it comes into contact with the bottom surface 2f of the locking member 2b. While the second element 3 is being led towards the closed position, the protrusion 4b moves beneath the locking member 2b towards a bottom edge 2i situated on that end of the locking member 2b which is facing in the locking direction L, whereupon the locking member is at least partially forced upwards by the engagement member. More precisely, the protrusion 4b displaces upwards that end of the locking member 2b which is facing in the locking direction L, so that the locking element 2b rotates about an imaginary axis which is horizontal and perpendicular to the locking direction L.

Here reference is made to FIG. 3a. Once the first surface region 4f has passed the contact part 2y, the locking member moves towards the locking position, owing to gravitational influence and the position of the second surface region 4g, in relation to the first surface region 4f, farther away in a vertical direction from the centre of gravity CG of the locking member. More precisely, once the protrusion 4b, with the second element 3 in the closed position, has passed the inner, bottom edge 2i (FIG. 3), the locking member 2b returns towards the locking position under the influence of solely gravitational force, so as to assume the locking position. As it moves towards the locking position, the locking member 2b rotates back about an imaginary axis which is horizontal and perpendicular to the locking direction L, so that its end facing in the locking direction L at least partially ends up at a lower level than an upper portion of the engagement member 4a, i.e. an upper portion of the protrusion 4b. The protrusion 4b is in this case situated farther away in the locking direction L than the locking member 2b. In the locking position, the locking member 2b, when no opening force, i.e. a force which acts upon the second locking part 2 and is directed oppositely to the locking direction L, is present on the locking device, is in contact with the supporting surfaces 2c, the second inner transverse surface 2e and possibly with the engagement member 4a. In this embodiment and in this position, however, the locking member 2b, if no opening force is present, has no contact with the first inner transverse surface 2p and the upper, inner surface 2m.

Here reference is made to FIG. 4. In the case of a force directed opposite to the locking direction L and acting upon the second locking part 2, the locking member 2b in the locking position is arranged, through bearing contact in a first contact region 2l against the upper, inner surface 2m and the first inner transverse surface 2p of the holder space 2x, as well as bearing contact in a second contact region 22 against the protrusion 4b, the second contact region 22 lying farther away in the locking direction L than the first contact region 2l, to prevent movement of the second locking part 4 in a direction opposite to the locking direction L. The locking member, as a result of lying wedged between the upper, inner surface 2m and the first inner transverse surface 2p of the holder space 2x and the protrusion 4b, therefore prevents movement of the second locking part 4 in a direction opposite to the locking direction L. More precisely, the locking member 2b has at an end facing in a direction opposite to the locking direction L, an upper, outer edge 2k and a lower, outer edge 2n. The movement of the second locking part 4 in a direction opposite to the locking direction L is herein prevented owing to the bearing contact of the locking member 2b, with an inner surface 2j, against the protrusion 4b, the bearing contact of the locking member 2b, with the upper, outer edge 2k, against the upper, inner surface 2m, and the bearing contact of the locking member 2b, with the lower, outer edge 2n, against the first inner transverse surface 2p, the region of the bearing contact against the protrusion 4b lying farther away in the locking direction than the region of the bearing contact against the upper, inner surface 2m, and against the first inner transverse surface 2p. The position in FIG. 4 is here also referred to as the blocking position and contact can in this case be present between the locking member and the supporting surfaces 2c.

It should be noted that the configuration of the actuating part 4b should be such that the locking member 2b, in the locking position, cannot slide off the actuating part. More precisely, the second surface region 4g should be sufficiently steep to prevent the locking member 2b from sliding off. More generally, the inclination on the second surface region 4g is matched to the inclination of the locking member 2b to prevent the locking member 2b from sliding off in the event of an opening force. In addition, the distance between a lower side of the engagement member 4a and a lower, inner surface 2s in the locking member holder 2a is so small that a downward bending of the engagement member 4a when the same is subjected to load is prevented by contact with the said lower, inner surface 2s. This means reduced demands upon the flexural rigidity of the engagement member 4a, which simplifies the construction.

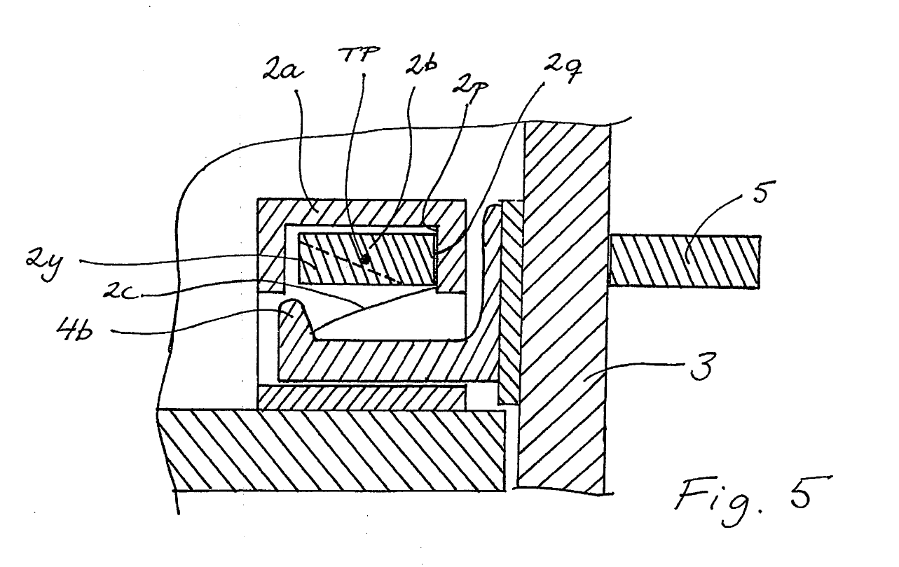

Here reference is made to FIG. 5. When an activating member 5, in the form of a permanent magnet 5, is installed outside the second element 3 (the door) in the vicinity of the locking device, a magnetic force is created which attracts the locking member 2b towards the activating member 5. Here, the magnet 5 forming the activating member 5, and the permanent magnet of the locking member 2b, are orientated with the poles in the same direction, so that an attraction force is created. Under the influence of the magnetic force, the locking member 2b rotates about an imaginary horizontal axis which is perpendicular to the locking direction L, and assumes an opening position in which an outer surface 2q of the locking member 2b, facing in a direction opposite to the locking direction L, bears against the substantially perpendicular first transverse surface 2p of the locking member holder 2a. The locking member 2b is here in a higher position than the protrusion 4b, so that the protrusion 4b, in the event of an opening relative movement between the elements 1, 3 from the closed position, can move in a direction opposite to the locking direction L past the locking member 2b. In order to facilitate the said rotation of the locking member 2b under the influence of magnetic force, it is important, when unlocking, to avoid applying an opening force to the locking device.

It should be noted that, where the locking member 2b comprises a permanent magnet, then the activating member 5 can alternatively comprise a temporary magnet. Conversely, the locking member 2b can comprise a temporary magnet and the activating member 5 can comprise a permanent magnet. As a further alternative, the activating member can be an electromagnet.

FIG. 5a shows the locking device with an assembly tool 6 for fitting the first and the second locking part 2, 4 to the first and second element 1, 3 respectively. The assembly member 6 is arranged to be detachably connected to the second locking part 4, so that at least a part of the assembly tool 6 is situated on the top side of the engagement member 4a. A top surface on part of the assembly tool which is intended to be inserted through the opening 2g in the locking member holder 2a is here located level with or above the actuating part 4b. Moreover, the assembly tool 6 has a portion which, in the inserted state of the engagement member, extends outside the locking member holder 2a and above the opening 2g. The assembly tool 6 can also comprise a part (not shown in FIG. 5a) which is situated beneath the engagement member 4a and which adjusts the vertical position of the second locking part 4 in relation to the first locking part 2. In addition, the assembly tool can comprise means, for example in the form of distancing parts, for correctly positioning the second locking part 4 in the lateral direction of the first locking part 2.

In the course of assembly, or already during factory production, the assembly tool 6 is applied to the second locking part 4, and the engagement member 4a is then led into the second locking part to a position in which the locking member 2b, in the fitted state of the locking device, can assume the locking position to prevent movement of the second locking part 4 in a direction opposite to the locking direction L. That portion of the assembly tool 6 which, in the inserted state of the engagement member, extends outside the locking member holder 2a and above the opening 2g, ensures, by means of contact bearing against the outside of the locking member holder 2a, that the engagement member 4a is not pushed in too far, but is instead placed in a desired position in the locking direction L. Moreover, the assembly tool pushes the contact part 2y of the locking member 2b upwards and, through bearing contact against the locking member 2b, prevents the contact part 2y from moving into the path of the actuating part 4b.

After this, the locking device assembled with the aid of the assembly tool is placed on the upward-facing surface 1a in the first element, approximately in the desired position, though somewhat displaced in a direction opposite to the locking direction L. During this placement, the thin protective film remains over the tape on both the bottom surface 2t of the first locking part 2 and the rear side of the second locking part 4 (cf. FIG. 2a). Then the second element 3 is moved carefully into the closed position, i.e. the position in which the locking effect is to act, whereupon the locking device assembled with the aid of the assembly tool is moved somewhat in the locking direction after contact has occurred between the flat surface of the second element 3 and the flat rear side 4h of the second locking part 4. The second element 3 is thereafter moved carefully in a direction opposite to the locking direction L. After this, the position of the locking part 2 is suitably marked (for example with a pen on the upward-facing surface 1a or with a special configuration of the tape on the upward-facing surface 1a), the protective film is removed from its adhesive surface, and the first locking part 2 is fixed in the marked position. After this, the protective film on the rear side 4h of the second locking part 4 is removed (cf. FIG. 2a) and the second locking part 4 is moved about 2 mm out of the first locking part 2 in a direction opposite to the locking direction L. Then, the second element 3 is moved to the closed position, whereupon the second locking part 4 gets jammed on the second element 3 and remains there when the second element 3 is moved in a direction opposite to the locking direction L. After this, the assembly tool is removed, the tape is subjected to extra pressure for good adhesion and the fitting is complete (after possible bonding agent hardening according to the instructions of the manufacturer).

The assembly tool 6 therefore provides an opportunity to fit the locking device in a very simple and quick manner.

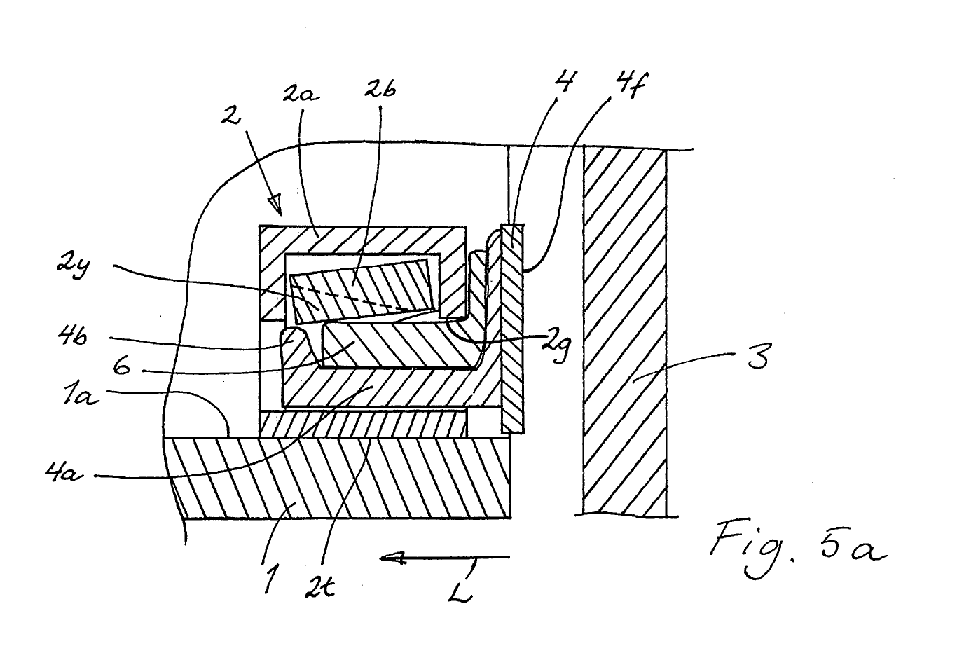

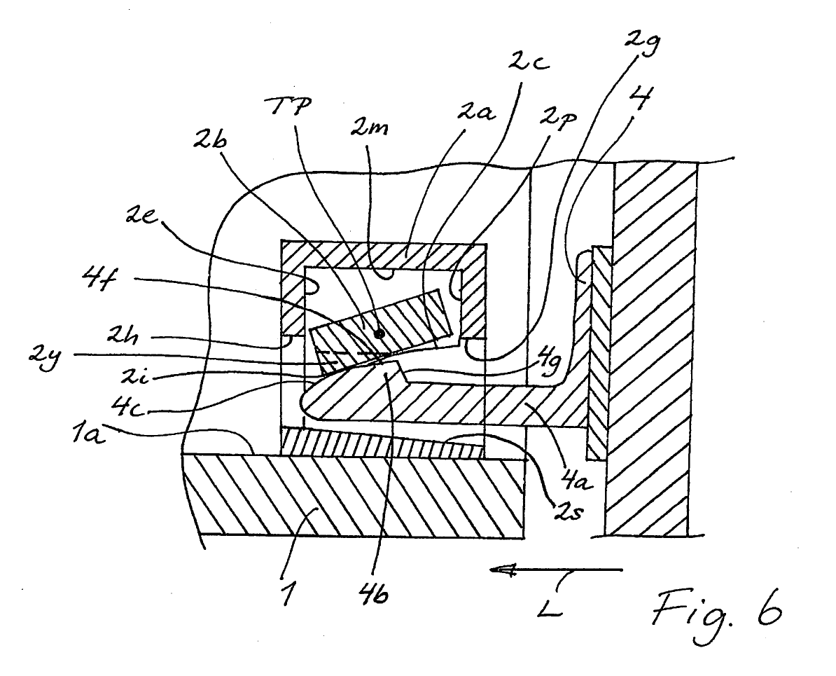

FIG. 6 shows an alternative embodiment of the locking device, conforming to the embodiment in FIG. 1-5, with the exception of the following:

A free end of the engagement member 4a, comprising the protrusion 4b, is shaped with a rounded top surface 4c, which slopes downwards in the locking direction L. The top surface 4c of the engagement member 4a is configured such that, while the second locking part 4 is moving in the locking direction L, the first contact between the engagement member 4a and the locking member 2b takes place at the bottom edge 2i, which is situated on that end of the locking member 2b which faces in the locking direction L, after which the protrusion 4b displaces upwards that end of the locking member 2b which faces in the locking direction L, so that the locking element 2b rotates about an imaginary axis horizontal and perpendicular to the locking direction L, contact being maintained between the bottom edge 2i of the locking member 2b and the top surface 4c of the engagement member 4a. One advantage with the top surface 4c is that the locking member 2b is actuated at a relatively far distance from its centre of gravity, which prevents tendencies to an initial translational movement of the locking member in the upward direction, which, in turn, eliminates the risk of a “chest drawer effect” when the locking member 2b is displaced, i.e. the top surface 4c produces a very favourable force action, which further reduces the friction forces between the locking member 2b and its holder 2a.

The embodiment in FIG. 6 also has a lower, inner surface 2s in the locking member holder 2a, which slopes gently upwards in the locking direction L. This allows the outer opening 2g to be made larger, which, in turn, allows greater tolerance variances for the entry of the engagement member 4a into the locking member holder 2a. At the same time, the, in the locking direction L, more remote higher portion of the lower, inner surface 2s, by virtue of its vicinity to the engagement member 4a, prevents the latter, for example should a person attempt to pull the locking device apart when the locking member 2b is in the locking position, from being bent downwards such that it disengages from the locking member 2b.

In addition, the cams 2c in the embodiment in FIG. 6 are shaped such that their inclination decreases in a direction opposite to the locking direction L. This means that the locking member 2b, during at least a part of each of its rotation movements, is supported at a distance from its ends. This means, in turn, that the point of support for the locking member 2b in the course of rotation lies relatively close to its centre of gravity, which is an advantage when the locking member 2b, under the influence of the magnetic force, assumes its opening position, since the lever arm of the centre of gravity becomes shorter and the necessary magnetic force therefore becomes less.

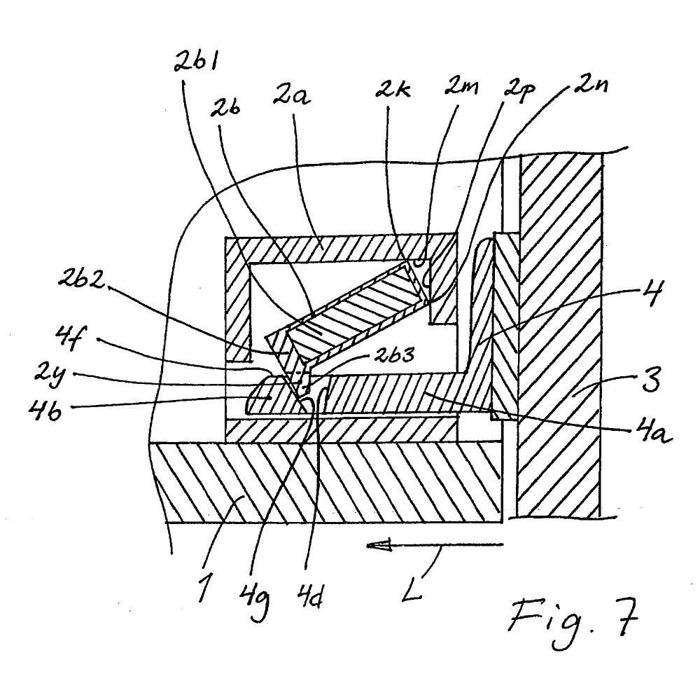

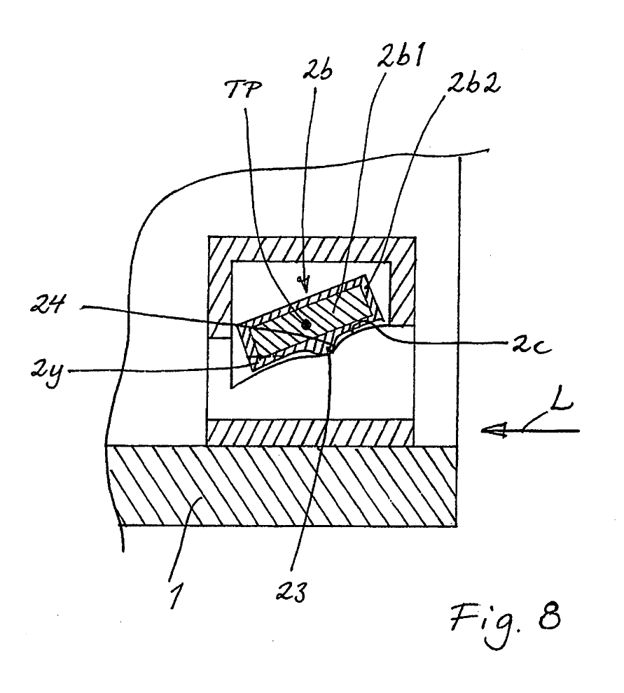

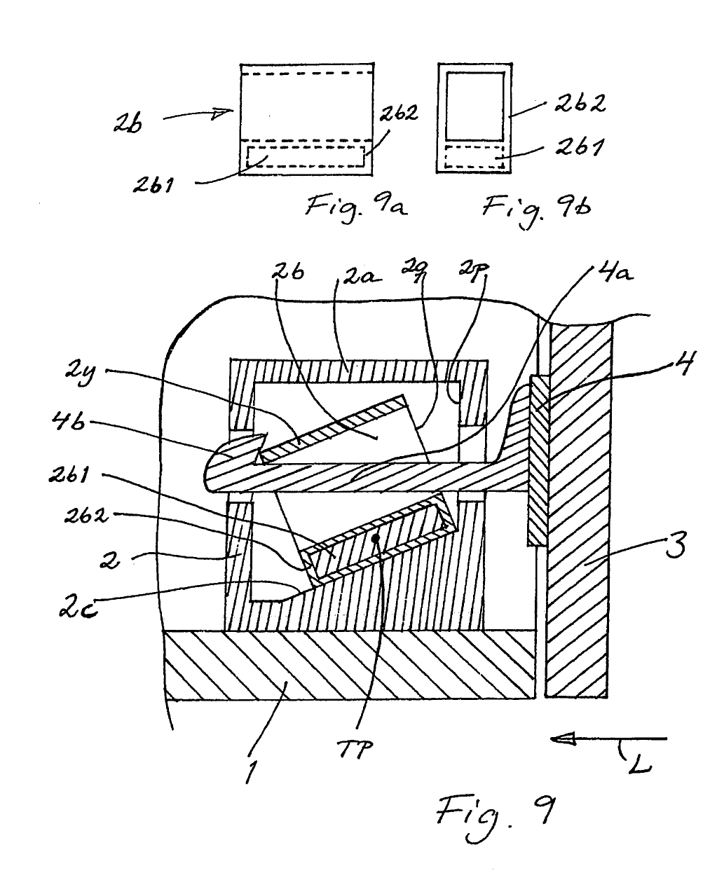

FIG. 7 shows a further alternative embodiment of the locking device, conforming to the embodiment in FIG. 1-5, with the exception of the following:

The locking member 2b comprises a somewhat elongated parallelepipedal permanent magnet 2b1, which is enclosed by a casing 2b2 made of a non-magnetic material, for example injection moulded plastic. On the casing 2b2 is formed a downwardly directed protrusion 2b3 having a contact part 2y, which contact part 2y, in a locking position of the locking member 2b, is located in the motional path of an actuating part 4b. The actuating part 4b is formed by a recess in the engagement member 4a. The actuating part has first surface region 4f and a second surface region 4g, the first surface region 4f being situated, in relation to the second surface region 4g, farther away in the locking direction L and farther away in a direction parallel with the movement of the contact part 2y out of the path of the actuating part 4b, which means that the contact part 2y, once the first surface region 4f in the locking direction has passed the contact part 2y, moves into the path of the actuating part 4b, i.e. the protrusion 2b3 moves at least partially into the recess 4d, and the locking member 2b assumes the locking position, whereby the movement of the second locking part 4 in a direction opposite to the locking direction L is prevented in a manner corresponding to that described above with reference to FIG. 4.

FIG. 8 shows another alternative embodiment of the locking device, conforming to the embodiment in FIG. 1-5, with the exception of the following:

The locking member 2b comprises a somewhat elongated parallelepipedal permanent magnet 2b1, which is enclosed by a casing 2b2 made of a non-magnetic material. On the lower side of the casing is formed a protrusion 23, which is arranged to extend into recesses 24 in the cams 2c, so that the locking member 2b, when rotating from the locking position to the opening position, is supported by the contact of the protrusion 23 with the recesses 24 in the cams. Since the protrusion 23 is situated relatively close to the centre of gravity CG, the moment which the magnetic force, in the opening position, has to surmount is relatively small. This means, in turn, that the demands upon the strength of the magnet(s) can be reduced. It should be pointed out that, in the event of an opening force, the protrusion 23 can be moved out of the recesses 24, so that a blocking position is present as described with reference to FIG. 4.

FIGS. 9, 9a and 9b show another embodiment of the locking device, having a first and a second locking part 2, 4 which are fitted to a first and a second element 1, 3 respectively. The first locking part 2 comprises a locking member 2b, which, in turn, comprises a somewhat elongated parallelepipedal permanent magnet 2b1, (in FIGS. 9a and 9b indicated with dashed lines), and a casing 2b2 made of a non-magnetic material, which partly encloses the permanent magnet 2b1 and moreover, above the permanent magnet, forms a short tube through which an actuating part 4b belonging to an engagement member 4a of the second locking part 4 can move. The locking member 2b comprises a contact part 2y, which, in the locking position and the opening position, is situated respectively in and outside the path of the actuating part 4b. The centre of gravity CG of the locking member is located beneath the actuating part 4b and the contact part 2y.

The locking member 2b is situated in a locking member holder 2a and, in the locking position, is arranged to be supported against a supporting surface 2c which slopes downwards in the locking direction. When an activating member (cf. FIG. 5), in the form of a permanent magnet, is installed outside the second element 3 in the vicinity of the locking device, a magnetic force is created which attracts the locking member 2b towards the activating member. Under the influence of the magnetic force, the locking member 2b rotates about an imaginary horizontal axis which is perpendicular to the locking direction L, and assumes an opening position in which an outer surface 2q of the locking member 2b, facing in a direction opposite to the locking direction L, bears against a substantially perpendicular first transverse surface 2p of the locking member holder 2a. The contact part 2y is here located outside the path of the actuating part 4b, so that the actuating part 4b, in the event of an opening relative movement between the elements 1, 3 from the closed position, can move in a direction opposite to the locking direction L past the locking member 2b.

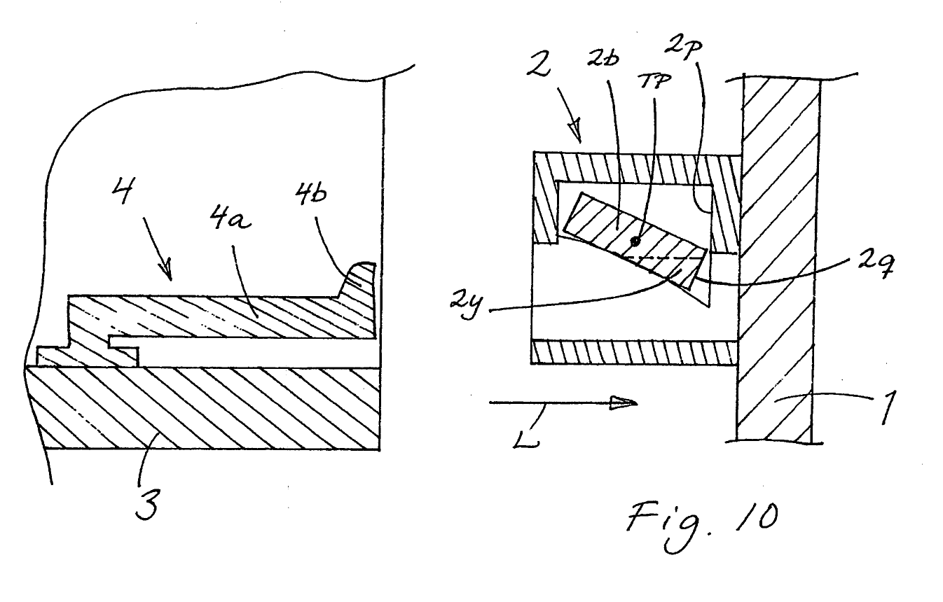

FIG. 10 shows another embodiment of the locking device, having a first and a second locking part 2, 4 which are fitted to a first and a second element 1, 3 respectively.

In this case, the first element is a door 1 and the second element is a cupboard 3. Even though the cupboard 3 does not perform any movement in relation to the surroundings, according to the definition of the locking direction L which is adopted in this representation the second locking part 4, at least in the vicinity of the first locking part 2, when the locking parts 2, 4 are brought together, moves in relation to the first locking part 2 in a locking direction L. The locking parts 2, 4 per se are configured substantially the same as in the embodiment described with reference to FIG. 1-5, with the difference that the magnetic force which is created upon the installation of an activating member (cf. FIG. 5) in the form of a permanent magnet, is directed parallel with the locking direction L. More precisely, if the activating member is installed outside the first element 1 in the vicinity of the locking device, a magnetic force is created which attracts the locking member 2b towards the activating member. Under the influence of the magnetic force, the locking member 2b rotates about an imaginary horizontal axis which is perpendicular to the locking direction L, and assumes an opening position in which an outer surface 2q of the locking member 2b, facing in the locking direction L, bears against a substantially perpendicular first transverse surface 2p of the locking member holder 2a. In this case, a contact part 2y of the locking member 2b is located outside the path for an actuating part 4b of an engagement member 4a belonging to the second locking part 4, so that the actuating part 4b, in the event of an opening relative movement between the elements 1, 3 from the closed position, can move in a direction opposite to the locking direction L past the locking member 2b.

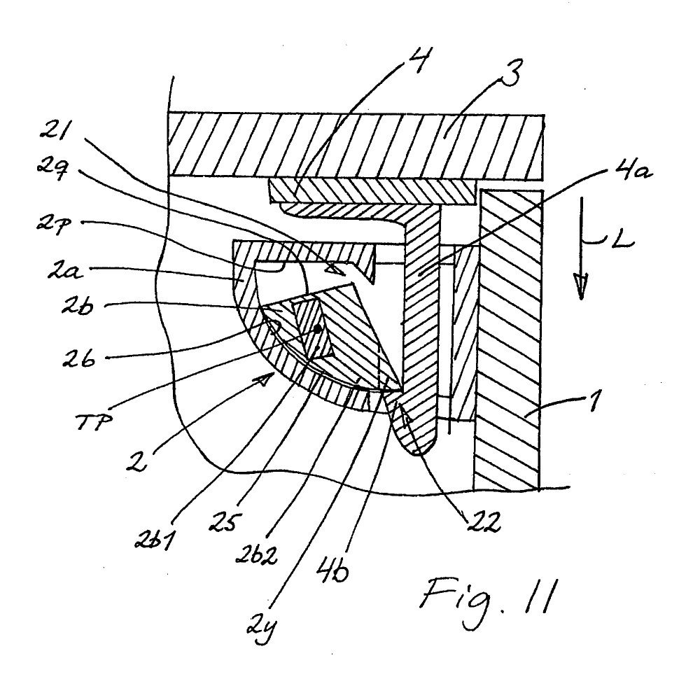

FIG. 11 shows a further embodiment of the locking device, having a first and a second locking part 2, 4 which are fitted to a first and a second element 1, 3 respectively. In a locking manoeuvre, the second locking part 4 moves in relation to the first locking part 2 in a locking direction L which is not horizontal but vertical and downwardly directed. The first locking part 2 comprises a locking member 2b, which, in turn, comprises a somewhat elongated parallelepipedal permanent magnet 2b1 and a casing 2b2 made of a non-magnetic material, which encloses the permanent magnet 2b1. The locking member 2b comprises a contact part 2y, which, in a locking position and an opening position, is situated respectively in and outside the path of an actuating part 4b of an engagement member 4a belonging to the second locking part 4. The centre of gravity CG of the locking member is in the opening position in a higher position than in the locking position. It should be pointed out that the embodiment in FIG. 11 comprises means, for example in the form of a stop lug, etc. (not shown), which prevents the locking member 2b, in the absence of the engagement member 4a, from moving too far into the path of the engagement member.

The first locking part 2 comprises a locking member holder 2a, in which the locking member 2b is situated. The locking member 2b has a convex surface 25, which is matched to a concave inner surface 26 in the locking member holder 2a, which surfaces are configured and orientated such that the locking member 2b, under solely gravitational influence, moves towards the locking position. In the locking position, the locking member 2b, through bearing contact in a first contact region 2l against the locking member holder 2a and bearing contact in a second contact region 22 against the actuating part 4b, which second contact region 22 lies farther away in the locking direction L than the first contact region 2l, prevents movement of the second locking part 4 in a direction opposite to the locking direction L.

When an activating member (cf. FIG. 5), in the form of a permanent magnet, is installed outside the second element 3 in the vicinity of the locking device, a magnetic force is created which attracts the locking member 2b towards the activating member. Under the influence of the magnetic force, the locking member 2b moves under rotation about an imaginary horizontal axis which is perpendicular to the locking direction L, and assumes an opening position in which an outer surface 2q of the locking member 2b, facing in a direction opposite to the locking direction L, bears against a substantially horizontal first transverse surface 2p of the locking member holder 2a. The contact part 2y is here located outside the path of the actuating part 4b, so that the actuating part 4b, in the event of an opening relative movement between the elements 1, 3 from the closed position, can move in a direction opposite to the locking direction L past the locking member 2b.

1. A locking device
comprising a first locking part, a second locking part, a first element, and a second element, said first and second locking parts arranged in a fitted state of the locking device, to be fixedly connected to said first and second elements, wherein when said first and second locking parts are brought together said second locking part moves in relation to said first locking part in a locking direction (L),
and wherein said first locking part comprises a locking member comprising a temporary magnet or a permanent magnet, said first locking part comprising a locking member holder arranged to support said locking member without said locking member being fixed to said locking member holder, said locking member being movable in relation to said locking member holder, said second locking part comprising an actuating part, said locking member comprising a contact part, and said locking device being arranged such that, in the fitted state of said locking device, movement of said contact part out of or into the path of said actuating part corresponds to at least partially upward and at least partially downward movement of the center of gravity (CG) of the locking member, said locking device being arranged such that, in the fitted state of said locking device, and once said actuating part, when moving in said locking direction (L), has passed said contact part, said contact part moves into the path of said actuating part, so that said locking member, through bearing contact against said locking member holder and against said actuating part, can prevent movement of said second locking part in a direction opposite to said locking direction (L), and said locking device being arranged such that, in the fitted state of said locking device, and when a force generated by a magnetic field is acted upon by the temporary or permanent magnet, said contact part moves out of the path of said actuating part.

2. A locking device according to claim 1, wherein said locking direction (L), at least when said second locking part is close to said first locking part, is substantially horizontal, and said actuating part is arranged to move beneath at least a part of said locking member.

3. A locking device according to claim 1, wherein said locking direction (L), at least when said second locking part is close to said first locking part, is substantially horizontal, and said actuating part is arranged to move beneath the center of gravity (CG) of said locking member.

4. A locking device according to claim 3, wherein said locking member is substantially parallelepipedal, and said first locking part is arranged such that said locking member, when said contact part is positioned in the path of said actuating part, is inclined.

5. A locking device according to claim 4, wherein said locking member is provided in the form of a parallelepipedal elongated permanent magnet.

6. A locking device according to claim 2, wherein said first locking part includes at least one supporting surface, which at least partially slopes downwards in said locking direction (L), and wherein said locking member is arranged, when said contact part is positioned in the path of said actuating part, solely under the influence of gravitational force, to be supported by said supporting surface.

7. A locking device according to claim 1, wherein said locking member is arranged, when said locking device is in the fitted state, and when a force generated by a magnetic field is acted upon by said temporary or permanent magnet, to bear against a substantially vertical first inner surface, substantially perpendicular to said locking direction (L), in said locking member holder.

8. A locking device according to claim 1, comprising an assembly tool for fitting said first and said second locking parts to said first and second elements, said assembly tool arranged, through bearing contact against said locking member, to prevent said contact part from moving into the path of said actuating part.

9. A locking device according to claim 1, wherein said second locking part comprises an engagement member comprising said actuating part, which engagement member is elongated in the locking direction (L), and said locking device being arranged such that, if the movement of said second locking part in a direction opposite to said locking direction (L) is prevented, said locking member holder, through contact with said engagement member, interferes with the bending of said engagement member in a direction away from said bearing contact of said locking member against said locking member holder.
